(19) United States
(12) Patent Application Publication
(10) Pub. No.: US 2019/0134981 A1
(43) Pub. Date: May 9, 2019

(54) LIQUID JET HEAD, METHOD OF MANUFACTURING SAME, AND LIQUID JET RECORDING DEVICE

(71) Applicant: SII Printek Inc., Chiba-shi (JP)

(72) Inventors: Shunsuke YAMAZAKI, Chiba-shi, Chiba (JP); Naohiro TOMITA, Chiba-shi, Chiba (JP); Masaru MIDORIKAWA, Chiba-shi, Chiba (JP); Yuki YAMAMURA, Chiba-shi, Chiba (JP); Shuji SATO, Chiba-shi, Chiba (JP)

(21) Appl. No.: 16/181,912

(22) Filed: Nov. 6, 2018

(30) Foreign Application Priority Data
Nov. 9, 2017 (JP) 2017-216268

(51) Int. Cl. B41J 2/14; B41J 2/16

(52) U.S. Cl. CPC B41J 2/1433; B41J 2/1623; B41J 2/162

(57) ABSTRACT

A liquid jet head capable of a stable jet operation is provided. The liquid jet head includes a liquid jet head chip adapted to jet liquid, a flow channel member having a flow channel adapted to guide the liquid to the liquid jet head chip, an adhesive layer adapted to bond the flow channel member and the liquid jet head chip to each other, and an elastic body softer than the adhesive layer and disposed between the flow channel member and the liquid jet head chip.

### RELATED APPLICATIONS

This application claims priority under 35 U.S.C. § 119 to Japanese Patent Application No. 2017-216268 filed Nov. 9, 2017, the entire content of which is hereby incorporated by reference.

### BACKGROUND OF THE INVENTION

### 1. Field of the Invention

The present disclosure relates to a liquid jet head, a method of manufacturing the liquid jet head and a liquid jet recording device.

### 2. Description of the Related Art

As one of liquid jet recording devices, there is provided an inkjet type recording device for ejecting (jetting) ink (liquid) on a recording target medium such as recording paper to perform recording of images, characters, and so on.

In the liquid jet recording device of this type, it is arranged that the ink is supplied from an ink tank to an inkjet head (a liquid jet head), and then the ink is ejected from nozzles of the inkjet head toward the recording target medium to thereby perform recording of the images, the characters, and so on. Further, in such an inkjet head, there is used an adhesive for sealing the ink (see, e.g., JP-A-2013-1008).

In such a liquid jet head, it is desirable for the variation in landing point (landing position) on the recording target medium of the ink jetted from a nozzle to be small. Therefore, it is desired to provide a liquid jet head capable of performing the stable jet operation, a method of manufacturing the liquid jet head, and a liquid jet recording device equipped with such a liquid jet head.

### SUMMARY OF THE INVENTION

A liquid jet head according to an embodiment of the disclosure includes a liquid jet head chip adapted to jet the liquid, a flow channel member having a flow channel adapted to guide the liquid to the liquid jet head chip, an adhesive layer adapted to bond the flow channel member and the liquid jet head chip to each other, and an elastic body softer than the adhesive layer and disposed between the flow channel member and the liquid jet head chip.

A liquid jet recording device according to an embodiment of the present disclosure is equipped with the liquid jet head according to an embodiment of the present disclosure, and a carriage to which the liquid jet head is attached.

A method of manufacturing a liquid jet head according to an embodiment of the disclosure includes the steps of preparing a flow channel member having a flow channel, and a liquid jet head chip, disposing an elastic body between the flow channel member and the liquid jet head chip, and curing the adhesive to thereby form an adhesive layer adapted to bond the flow channel member and the liquid jet head chip to each other, wherein the elastic body is formed from a material softer than the adhesive layer having cured.

According to the liquid jet head and the liquid jet recording device related to an embodiment of the present disclosure, it is arranged that the elastic body softer than the adhesive layer for bonding the flow channel member and the liquid jet head chip to each other is disposed between the flow channel member and the liquid jet head chip. Therefore, it is possible to prevent the influence of the pressure wave in the jet operation generated at, for example, a certain position in the liquid jet head chip from being exerted to the vicinity of that position. Therefore, the stable jet operation becomes possible. Further, according to the method of manufacturing the liquid jet head according to the embodiment of the present disclosure, it is possible to manufacture the liquid jet head capable of such a stable jet operation.

### BRIEF DESCRIPTION OF THE DRAWINGS

FIG. 1 is a schematic perspective view showing a schematic configuration example of a liquid jet recording device according to an embodiment of the disclosure.

FIG. 2 is a schematic diagram showing a detailed configuration example of a circulation mechanism and so on shown in FIG. 1.

FIG. 3 is a schematic side view showing a detailed configuration example of the liquid jet head shown in FIG. 1.

FIG. 4A is a plan view showing a flow channel plate included in the liquid jet head shown in FIG. 1.

FIG. 4B is a plan view showing another flow channel plate included in the liquid jet head shown in FIG. 1.

FIG. 5A is a schematic cross-sectional view showing a vicinity of an interface between a flow channel member and a liquid jet head chip included in the liquid jet head shown in FIG. 1.

FIG. 5B is a schematic plan view showing the vicinity of the interface between the flow channel member and the liquid jet head chip shown in FIG. 5A.

FIG. 6 is a schematic plan view showing the liquid jet head chip shown in FIG. 3.

FIG. 7 is a schematic exploded perspective view of the liquid jet head chip shown in FIG. 3.

FIG. 8 is a schematic plan view of the liquid jet head chip shown in FIG. 3.

FIG. 9 is a schematic cross-sectional view along the line IX-IX shown in FIG. 8 in the liquid jet head chip shown in FIG. 3.

FIG. 10A is a schematic cross-sectional view showing one process of a method of manufacturing the liquid jet head shown in FIG. 1.

FIG. 10B is a schematic cross-sectional view showing one process following the process shown in FIG. 10A.

FIG. 11 is a schematic plan view showing a vicinity of an interface between a flow channel member and a liquid jet head chip included in the liquid jet head as Modified Example 1.

FIG. 12 is a schematic plan view showing a vicinity of an interface between a flow channel member and a liquid jet head chip included in the liquid jet head as Modified Example 2.

FIG. 13 is a schematic cross-sectional view showing a vicinity of an interface between a flow channel member and a liquid jet head chip included in the liquid jet head as Modified Example 3.

FIG. 14 is a schematic cross-sectional view showing a vicinity of an interface between a flow channel member and a liquid jet head chip included in the liquid jet head as Modified Example 4.

### DETAILED DESCRIPTION OF THE PREFERRED EMBODIMENTS

An embodiment of the present disclosure will hereinafter be described in detail with reference to the drawings. It should be noted that the description will be presented in the following order.
1. Embodiment (an example in which a plurality of elastic bodies is disposed between a flow channel member and a head chip)
2. Modified Examples

Modified Example 1 (an example in which an elastic body is disposed so as to extend along a flow channel in an area between a plurality of flow channels of a flow channel member)

Modified Example 2 (an example in which a sheet-shaped elastic body having slits at positions corresponding to the flow channels is disposed between a flow channel member and a head chip)

Modified Example 3 (an example in which an elastic body is disposed so as to have contact with both of a flow channel member and a head chip)

Modified Example 4 (an example in which a flow channel member and a head chip are arranged to be fixed in the end surfaces of the flow channel member and the head chip)
3. Other Modified Examples

### 1. EMBODIMENT

### [Overall Configuration of Printer 1]

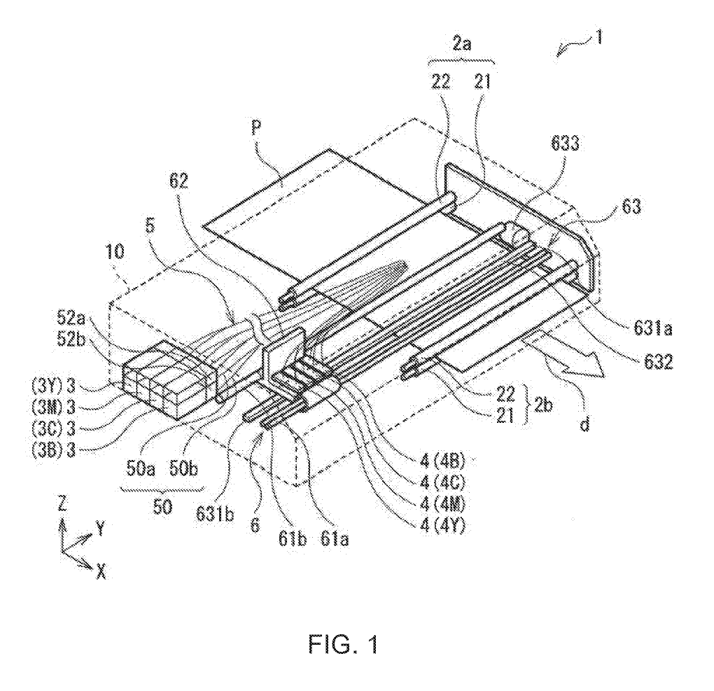

FIG. 1 is a perspective view schematically showing a schematic configuration example of a printer 1 as a liquid jet recording device according to one embodiment of the present disclosure. The printer 1 is an inkjet printer for performing recording (printing) of images, characters, and so on, on recording paper P as a recording target medium using ink 9 (see FIG. 3 described later).

As shown in FIG. 1, the printer 1 is provided with a pair of carrying mechanisms 2a, 2b, ink tanks 3, inkjet heads 4, an ink circulation mechanism 5, and a scanning mechanism 6. These members are housed in a housing 10 having a predetermined shape. It should be noted that the scale size of each member is accordingly altered so that the member is shown large enough to recognize in the drawings used in the description of the specification. Further, in the present specification, the description will be presented assuming a Z-axis direction shown in FIG. 1 as a vertical direction. In detail, the description will be presented assuming a +Z direction as an upward vertical direction, and a −Z direction as a downward vertical direction.

Here, the printer 1 corresponds to a specific example of the “liquid jet recording device” in the present disclosure, and the inkjet heads 4 (the inkjet heads 4Y, 4M, 4C, and 4B described later) each correspond to a specific example of the “liquid jet head” in the present disclosure.

The carrying mechanisms 2a, 2b are each a mechanism for carrying the recording paper P along the carrying direction d (an X-axis direction) as shown in FIG. 1. These carrying mechanisms 2a, 2b each have a grit roller 21, a pinch roller 22 and a drive mechanism (not shown). The grit roller 21 and the pinch roller 22 are each disposed so as to extend along a Y-axis direction (the width direction of the recording paper P). The drive mechanism is a mechanism for rotating (rotating in a Z-X plane) the grit roller 21 around an axis, and is constituted by, for example, a motor.

### (Ink Tanks 3)

The ink tanks 3 are each a tank for containing the ink 9 inside. As the ink tanks 3, there are disposed 4 types of tanks for individually containing 4 colors of ink 9, namely yellow (Y), magenta (M), cyan (C), and black (B), in this example as shown in FIG. 1. Specifically, there are disposed the ink tank 3Y for containing the yellow ink 9, the ink tank 3M for containing the magenta ink 9, the ink tank 3C for containing the cyan ink 9, and the ink tank 3B for containing the black ink 9. These ink tanks 3Y, 3M, 3C, and 3B are arranged side by side along the X-axis direction inside the housing 10.

It should be noted that the ink tanks 3Y, 3M, 3C, and 3B have the same configuration except the color of the ink 9 contained, and are therefore collectively referred to as ink tanks 3 in the following description.

### (Inkjet Heads 4)

The inkjet heads 4 are each a head for jetting (ejecting) the ink having a droplet shape from a plurality of nozzles H1, H2 described later to the recording paper P to thereby perform printing of images, characters, and so on. As the inkjet heads 4, there are disposed 4 types of heads for individually jetting the 4 colors of ink 9 respectively contained by the ink tanks 3Y, 3M, 3C, and 3B described above in this example as shown in FIG. 1. Specifically, there are disposed the inkjet head 4Y for jetting the yellow ink 9, the inkjet head 4M for jetting the magenta ink 9, the inkjet head 4C for jetting the cyan ink 9, and the inkjet head 4B for jetting the black ink 9. These inkjet heads 4Y, 4M, 4C, and 4B are arranged side by side along the Y-axis direction inside the housing 10.

It should be noted that the inkjet heads 4Y, 4M, 4C, and 4B have the same configuration except the color of the ink 9 used, and are therefore collectively referred to as inkjet heads 4 in the following description. Further, the detailed configuration of the inkjet heads 4 will be described later in detail.

### (Ink Circulation Mechanism 5)

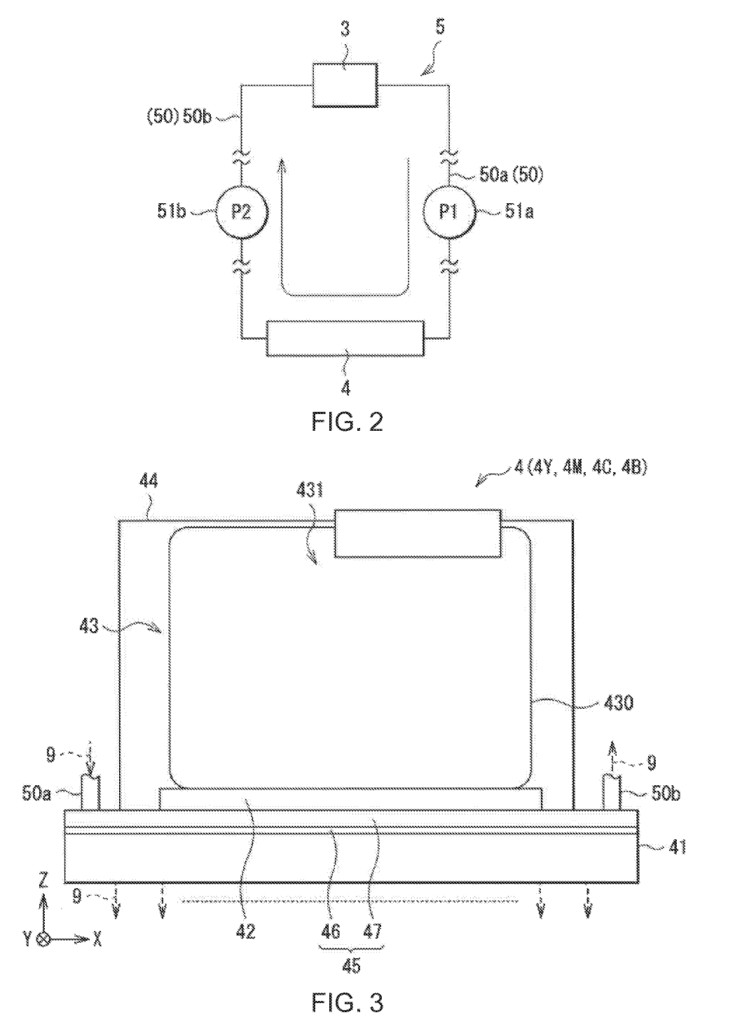

FIG. 2 is a schematic diagram showing a schematic configuration example of the ink circulation mechanism 5. The ink circulation mechanism 5 is a mechanism for circulating the ink 9 between the ink tanks 3 and the inkjet heads 4. The ink circulation mechanism 5 is provided with ink circulation channels 50 each constituted by an ink supply tube 50a and an ink discharge tube 50b, pressure pumps 51a provided respectively to the ink supply tubes 50a, and suction pumps 51b provided respectively to the ink discharge tubes 50b. The ink supply tubes 50a, the ink discharge tubes 50b are each formed of, for example, a flexible hose having flexibility to the extent of being capable of following the motion of the scanning mechanism 6 for supporting the inkjet heads 4.

The pressure pump 51a is for pressurizing the inside of the ink supply tube 50a to deliver the ink 9 to the inkjet head 4 through the ink supply tube 50a. Due to the function of the pressure pump 51a, the inside of the ink supply tube 50a between the pressure pump 51a and the inkjet head 4 is provided with positive pressure with respect to the inkjet head 4.

The suction pump 51b is for depressurizing the inside of the ink discharge tube 50b to suction the ink 9 from the inkjet head 4 through the ink discharge tube 50b. Due to the function of the suction pump 51b, the inside of the ink discharge tube 50b between the suction pump 51b and the inkjet head 4 is provided with negative pressure with respect to the inkjet head 4. It is arranged that the ink 9 can circulate between the inkjet head 4 and the ink tank 3 via the ink circulation channel 50 by driving the pressure pump 51a and the suction pump 51b.

### (Scanning Mechanism 6)

The scanning mechanism 6 is a mechanism for making the inkjet heads 4 perform a scanning operation along the width direction (the Y-axis direction) of the recording paper P. As shown in FIG. 1, the scanning mechanism 6 has a pair of guide rails 61a, 61b disposed so as to extend along the Y-axis direction, a carriage 62 movably supported by these guide rails 61a, 61b, and a drive mechanism 63 for moving the carriage 62 along the Y-axis direction. Further, the drive mechanism 63 is provided with a pair of pulleys 631a, 631b disposed between the pair of guide rails 61a, 61b, an endless belt 632 wound between the pair of pulleys 631a, 631b, and a drive motor 633 for rotationally driving the pulley 631a.

The pulleys 631a, 631b are respectively disposed in areas corresponding to the vicinities of both ends in each of the guide rails 61a, 61b. To the endless belt 632, there is connected the carriage 62. The carriage 62 has a pedestal 62a having a plate-like shape for mounting the four types of inkjet heads 4Y, 4M, 4C, and 4B described above, and a wall section 62b erected vertically (in the Z-axis direction) from the pedestal 62a. On the pedestal 62a, the inkjet heads 4Y, 4M, 4C, and 4B are arranged side by side along the Y-axis direction.

It should be noted that it is arranged that a moving mechanism for moving the inkjet heads 4 relatively to the recording paper P is constituted by such a scanning mechanism 6 and the carrying mechanisms 2a, 2b described above.

### [Detailed Configuration of Inkjet Heads 4]

Then, the detailed configuration example of the inkjet heads 4 will be described with reference to FIG. 3 in addition to FIG. 1. FIG. 3 is a side view (a Z-X side view) schematically showing the detailed configuration example of the inkjet heads 4.

The inkjet heads 4 according to the present embodiment are each an inkjet head of a so-called side-shoot type for ejecting the ink 9 from a central part in an extending direction of a plurality of channels (a plurality of channels C1 and a plurality of channels C2) in the head chip 41 described later. Further, the inkjet heads 4 are each an inkjet head of a circulation type which uses the ink circulation mechanism 5 (the ink circulation channels 50) described above to thereby use the ink 9 while circulated between the inkjet head 4 and the ink tank 3.

As shown in FIG. 3, the inkjet heads 4 are each provided with the head chip 41, a support member 42, a control mechanism 43, a cover 44 and a flow channel member 45. It should be noted that in FIG. 3, there is omitted the description of members such as a base plate and a nozzle guard disposed on the periphery of the head chip 41 in order to protect the head chip 41.

The support member 42 is a member disposed on the head chip 41 to support the circuit board 430 in the control mechanism 43 described later.

The head chip 41 is a member for jetting the ink 9 along the Z-axis direction. It should be noted that detailed configuration of the head chip 41 will be described later.

### (Control Mechanism 43)

The control mechanism 43 has the circuit board 430.

The circuit board 430 is a board for mounting a drive circuit (an electric circuit) for driving the head chip 41. The circuit board 430 is supported by (fixed to) the support member 42 described above, and is erected along a vertical direction (the Z-axis direction in this example).

### (Cover 44)

As shown in FIG. 3, the cover 44 is a member disposed so as to cover the periphery of the circuit board 430 on the head chip 41 to prevent the ink 9 from adhering to the circuit board 430.

### (Flow Channel Member 45)

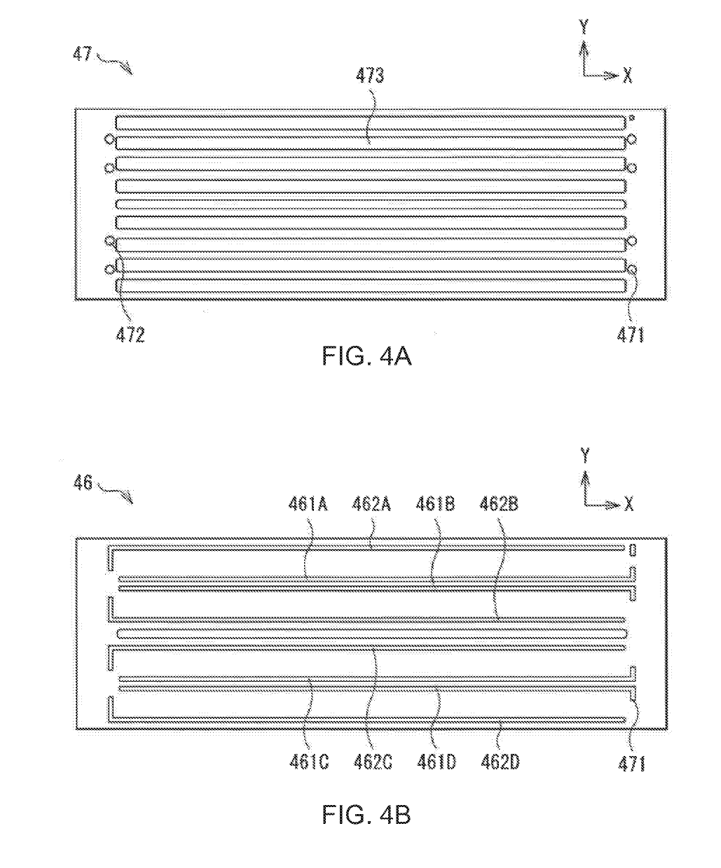

As shown in FIG. 3, the flow channel member 45 is a member obtained by stacking a flow channel plate 46 and a flow channel plate cover 47 on an upper surface of the head chip 41 in sequence. FIG. 4A and FIG. 4B are plan views showing the flow channel plate cover 47 and the flow channel plate 46, respectively, in the X-Y plane. It should be noted that between the flow channel plate cover 47 and the flow channel plate 46, there is disposed a film (not shown) having flexibility. As shown in FIG. 4A, the flow channel plate cover 47 has four inflow holes 471, four outflow holes 472, and a plurality of slits 473 each extending in the X-axis direction, and at the same time arranged side by side in the Y-axis direction. To the upper surface of the flow channel plate cover 47, there are connected the ink supply tubes 50a and the ink discharge tubes 50b in the ink circulation mechanism 5. It is arranged that the ink 9 supplied from the ink supply tubes 50a respectively inflows into the four inflow holes 471, and the ink 9 flowing out from the four outflow holes 472 inflows into the ink discharge tube 50b. As shown in FIG. 4B, the flow channel plate 46 has flow channels 461 (461A through 461D) and flow channels 462 (462A through 462D) each extending in the X-axis direction. It should be noted that one ends of the flow channels 461 are disposed at positions corresponding to the inflow holes 471 in the Z-axis direction, and one ends of the flow channels 462 are disposed at positions corresponding to the outflow holes 472 in the Z-axis direction. Due to such a configuration, it is arranged that the ink 9 having flowed from the ink supply tubes 50a into the flow channels 461 outflows from the flow channels 462 to the ink discharge tubes 50b via the head chip 41.

### (Adhesive Layer 48 and Elastic Body 49)

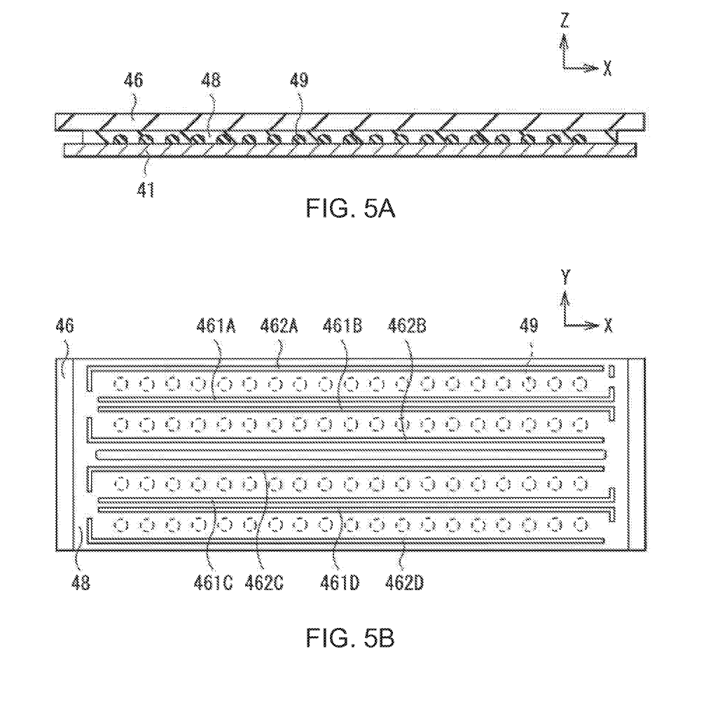

FIG. 5A is a schematic cross-sectional view showing a vicinity of an interface between the flow channel member 45 and the head chip 41 in an enlarged manner. Further, FIG. 5B is a schematic plan view showing a positional relationship between the flow channel member 45 (the flow channel plate 46) and elastic bodies 49 (described later) viewed from the head chip 41.

As shown in FIG. 5A, the flow channel plate 46 included in the flow channel member 45 and the head chip 41 are bonded to each other via the adhesive layer 48. Further, between the flow channel plate 46 and the head chip 41, there is disposed a plurality of elastic bodies 49 softer than the adhesive layer 48 having cured. Here, the description that “the elastic bodies 49 are softer than the adhesive layer 48 having cured” means the fact that the numerical value of the index of the hardness of the elastic bodies 49 with the surface exposed measured by, for example, a plunger testing machine is smaller than the numerical value of the index of the hardness of the adhesive layer 48 having cured. It should be noted that as the index of the hardness, there can be cited, for example, a Young's modulus. In other words, in the present embodiment, the Young's modulus of the elastic bodies 49 is lower than the Young's modulus of the adhesive layer 48. As the adhesive layer 48, there are preferably used, for example, thermoset resin such as epoxy, silicon series moisture-curable resin, or two-liquid mixture curable fluorinated resin. As the material constituting the adhesive layer 48, a material high in hardness after curing and high in resistance to the ink 9, namely a material hard to cause alteration such as dissolution or swelling by having contact with the ink 9 is preferable. On the other hand, as the constituent material of the elastic bodies 49, there can be cited, for example, silicone, epoxy, or rubber. Further, the constituent material of the elastic bodies 49 can also be an adhesive lower in hardness (e.g., Young's modulus) after curing than the material constituting the adhesive layer 48.

Further, it is preferable that the plurality of elastic bodies 49 is disposed so as to have contact with, for example, the upper surface of the head chip 41, and a part other than the part having contact with the upper surface of the head chip 41 is covered with the adhesive layer 48 as shown in FIG. 5B. In other words, it is preferable for the plurality of elastic bodies 49 to be disposed so as to be separated from the ink 9 at least by the adhesive layer 48. Further, the adhesive layer 48 and the elastic bodies 49 are disposed at positions corresponding to a peripheral area of the flow channel plate 46 other than the flow channels 461, 462. Further, it is preferable for the plurality of elastic bodies 49 to be discretely disposed along the extending direction (the X-axis direction) of the flow channels 461, 462.

### (Head Chip 41)

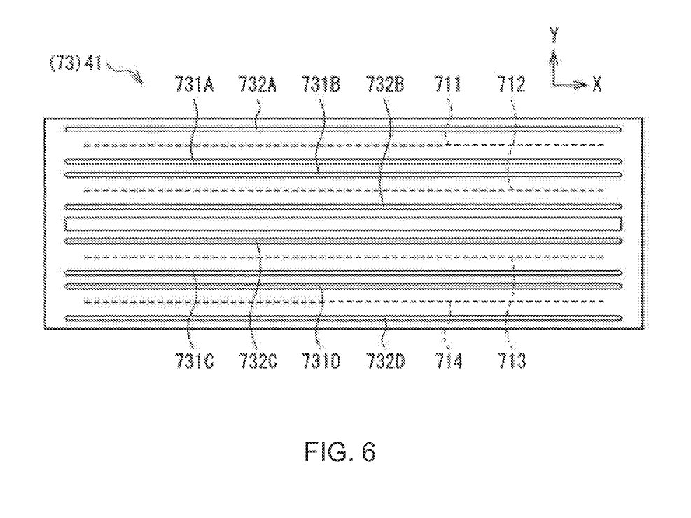

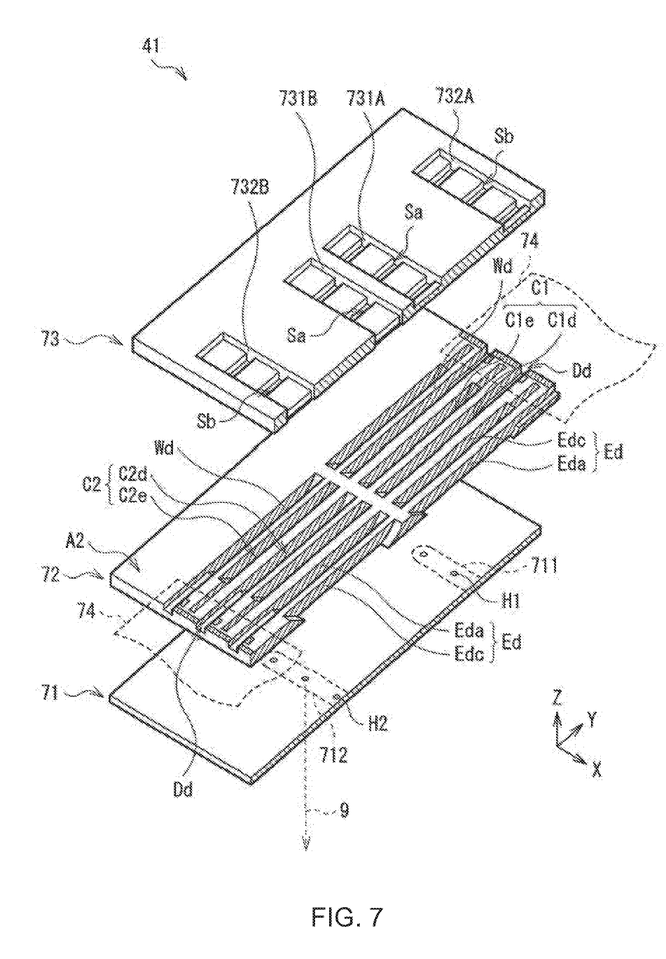

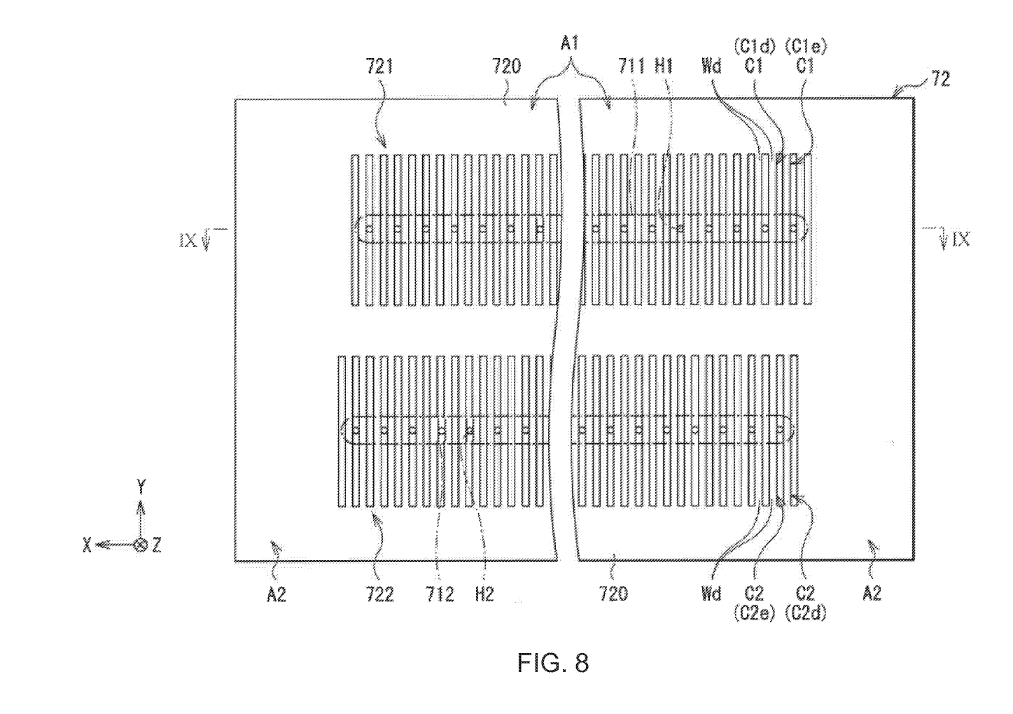

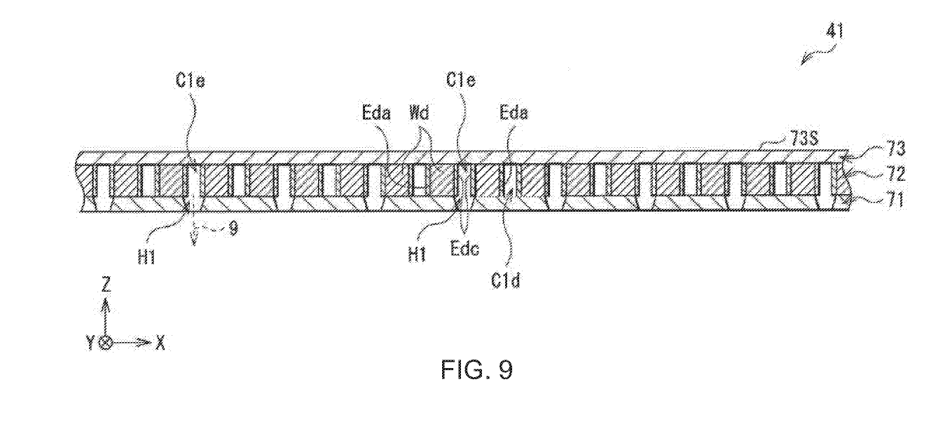

FIG. 6 is a schematic plan view (an X-Y top view) showing an appearance of the head chip 41 viewed from a direction of the flow channel member 45. Further, FIG. 7 is an exploded perspective view schematically showing a detailed configuration example of the head chip 41. FIG. 8 is a bottom view (an X-Y bottom view) schematically showing a configuration example of the head chip 41 in the state in which a nozzle plate 71 (a jet hole plate) shown in FIG. 7 is detached. FIG. 9 is a diagram schematically showing a cross-sectional configuration example (a Z-X cross-sectional configuration example) along the line IX-IX shown in FIG. 8. It should be noted that in FIG. 7 and FIG. 8, a half in the Y-axis direction of the head chip 41, namely a part of the area where the ink chambers 731A, 732A, 731B, and 732B are formed, is shown in an enlarged manner. Since the area where the ink chambers 731C, 732C, 731D, and 732D are formed in the head chip 41 also has the structure shown in FIG. 7 and FIG. 8 in essence, the description thereof will hereinafter be omitted.

As shown in FIG. 7, the head chip 41 is a member for jetting the ink 9 along the Z-axis direction, and is configured using a variety of types of plates. Specifically, as shown in FIG. 7, the head chip 41 is mainly provided with the nozzle plate 71, an actuator plate 72 and a cover plate 73. The nozzle plate 71, the actuator plate 72, the cover plate 73, and the flow channel member 45 described above are bonded to each other using, for example, an adhesive, and are stacked on one another in this order along the Z-axis direction. It should be noted that the description will hereinafter be presented with the flow channel member 45 side (the cover plate 73 side) along the Z-axis direction referred to as an upper side, and the nozzle plate 71 side referred to as a lower side.

### <Nozzle Plate 71>

The nozzle plate 71 is formed of a film member made of polyimide or the like having a thickness of, for example, about 50 μm, and is bonded to a lower surface of the actuator plate 72 as shown in FIG. 7 and FIG. 9. It should be noted that the constituent material of the nozzle plate 71 is not limited to the resin material such as polyimide, but can also be, for example, a metal material such as stainless steel. Further, although the nozzle plate 71 is provided with four nozzle columns (nozzle columns 711 through 714) each extending along the X-axis direction in reality as indicated by a dotted line in FIG. 6, the nozzle columns 711, 712 among those are shown alone in FIG. 7 and FIG. 8. These nozzle columns 711 through 714 are arranged along the Y-axis direction at predetermined intervals (FIG. 6).

The nozzle column 711 has a plurality of nozzles H1 formed in alignment with each other at predetermined intervals along the X-axis direction. These nozzles H1 each penetrate the nozzle plate 71 along the thickness direction (the Z-axis direction) of the nozzle plate 41, and are communicated with the respective ejection channels C1e in the actuator plate 72 as shown in, for example, FIG. 9. Specifically, as shown in FIG. 8, each of the nozzles H1 is formed so as to be located in a central part along the Y-axis direction on the ejection channel C1e. Further, the formation pitch along the X-axis direction in the nozzles H1 is made equal (equal in pitch) to the formation pitch along the X-axis direction in the ejection channels C1e. It is arranged that the ink supplied from the inside of the ejection channel C1e is ejected (jetted) from each of the nozzles H1 in such a nozzle column 711.

The nozzle column 712 similarly has a plurality of nozzles H2 formed in alignment with each other at predetermined intervals along the X-axis direction. Each of these nozzles H2 also penetrates the nozzle plate 71 along the thickness direction of the nozzle plate 41, and is communicated with the ejection channel C2e in the actuator plate 72. Specifically, as shown in FIG. 8, each of the nozzles H2 is formed so as to be located in a central part along the Y-axis direction on the ejection channel C2e. Further, the formation pitch along the X-axis direction in the nozzles H2 is made equal to the formation pitch along the X-axis direction in the ejection channels C2e. Although the details will be described later, it is arranged that the ink supplied from the inside of the ejection channel C2e is also ejected from each of the nozzles H2 in such a nozzle column 712. It should be noted that these nozzles H1, H2 each formed as a tapered through hole gradually decreasing in diameter in a downward direction.

### <Actuator Plate 72>

The actuator plate 72 is a plate formed of a piezoelectric material such as lead zirconate titanate (PZT). As shown in FIG. 9, the actuator plate 72 is formed by stacking two piezoelectric substrates different in polarization direction from each other on one another along the thickness direction (the Z-axis direction) (a so-called chevron type). It should be noted that the configuration of the actuator plate 72 is not limited to the chevron type. Specifically, it is also possible to form the actuator plate 72 with, for example, a single (unique) piezoelectric substrate having the polarization direction set one direction along the thickness direction (the Z-axis direction) (a so-called cantilever type). Further, in reality, the actuator plate 72 is provided with four channel columns each extending along the X-axis direction disposed side by side in the Y-axis direction so as to correspond to the four nozzle columns 711 through 714. However, in FIG. 7 and FIG. 8, the two channel columns 721, 722 among those are shown alone. These channel columns 721, 722 are arranged along the Y-axis direction at a predetermined interval.

In such an actuator plate 72, as shown in FIG. 8, an ejection area (jetting area) A1 of the ink 9 is disposed in a central part (the formation areas of the channel columns 721, 722) along the X-axis direction. On the other hand, in the actuator plate 72, a non-ejection area (a non-jetting area) A2 of the ink 9 is disposed in each of the both end parts (non-formation areas of the channel columns 721, 722) along the X-axis direction. The non-ejection areas A2 are located on the outer side along the X-axis direction with respect to the ejection area A1. It should be noted that the both end parts along the Y-axis direction in the actuator plate 72 each constitute a tail part 720.

As shown in FIG. 7 and FIG. 8, the channel column 721 described above has the plurality of channels C1 extending along the Y-axis direction. These channels C1 are arranged side by side so as to be parallel to each other at predetermined intervals along the X-axis direction. Each of the channels C1 is partitioned with drive walls Wd formed of a piezoelectric body (the actuator plate 72), and forms a groove section having a recessed shape in a cross-sectional view (see FIG. 9).

The channel column 722 similarly has the plurality of channels C2 extending along the Y-axis direction. These channels C2 are arranged side by side so as to be parallel to each other at predetermined intervals along the X-axis direction. Each of the channels C2 is also partitioned with the drive walls Wd described above, and forms a groove section having a recessed shape in a cross-sectional view (see FIG. 9).

Here, as shown in FIG. 7 and FIG. 8, in the channels C1, there exist the ejection channels C1e for ejecting the ink 9, and dummy channels C1d not ejecting the ink 9. In the channel column 721, the ejection channels C1e and the dummy channels C1d are alternately arranged along the X-axis direction. Each of the ejection channels C1e is communicated with the nozzle H1 in the nozzle plate 71 on the one hand, but each of the dummy channels C1d is not communicated with the nozzle H1, and is covered with the upper surface of the nozzle plate 71 from below on the other hand.

Similarly, in the channels C2, there exist the ejection channels C2e for ejecting the ink, and dummy channels C2d not ejecting the ink. In the channel column 722, the ejection channels C2e and the dummy channels C2d are alternately arranged along the X-axis direction. Each of the ejection channels C2e is communicated with the nozzle H2 in the nozzle plate 71 on the one hand, but each of the dummy channels C2d is not communicated with the nozzle H2, and is covered with the upper surface of the nozzle plate 71 from below on the other hand.

Further, as shown in FIG. 8, the ejection channels C1e and the dummy channels C1d in the channels C1 and the ejection channels C2e and the dummy channels C2d in the channels C2 are arranged in a staggered manner. Therefore, in each of the inkjet heads 4 according to the present embodiment, the ejection channels C1e in the channels C1 and the ejection channels C2e in the channels C2 are arranged in a zigzag manner. It should be noted that as shown in FIG. 7, in the actuator plate 72, in the part corresponding to each of the dummy channels C1d, C2d, there is formed a shallow groove section Dd communicated with an outside end part extending along the Y-axis direction in the dummy channel C1d, C2d.

As shown in FIG. 7 and FIG. 8, drive electrodes Ed extending along the Y-axis direction are disposed on the inner side surfaces opposed to each other in each of the drive walls Wd described above. As the drive electrodes Ed, there exist common electrodes Edc disposed on the inner side surfaces facing the ejection channels C1e, C2e, and active electrodes Eda disposed on the inner side surfaces facing the dummy channels C1d, C2d. It should be noted that the drive electrodes Ed (the common electrodes Edc and the active electrodes Eda) are each formed in the entire area in the depth direction (the Z-axis direction) on the inner side surface of the drive wall Wd as shown in FIG. 9.

The pair of common electrodes Edc opposed to each other in the same ejection channel C1e (or the same ejection channel C2e) are electrically connected to each other in a common terminal (not shown). Further, the pair of active electrodes Eda opposed to each other in the same dummy channel C1d (or the same dummy channel C2d) are electrically separated from each other. In contrast, the pair of active electrodes Eda opposed to each other via the ejection channel C1e (or the ejection channel C2e) are electrically connected to each other in an active terminal (not shown).

Here, in the tail part 720 described above, there is mounted a flexible printed circuit board 74 for electrically connecting the drive electrodes Ed and the circuit board 430 (FIG. 3) to each other as shown in FIG. 7. Interconnection patterns (not shown) provided to the flexible printed circuit board 74 are electrically connected to the common terminals and the active terminals described above. Thus, it is arranged that the drive voltage is applied to each of the drive electrodes Ed from the circuit board 430 via the flexible printed circuit board 74.

### <Cover Plate 73>

As shown in FIG. 7, the cover plate 73 is disposed so as to close the channels C1, C2 (the channel columns 721, 722) in the actuator plate 72. Specifically, the cover plate 73 is a plate-like member bonded to the upper surface of the actuator plate 72.

As shown in FIG. 6, the cover plate 73 has the ink chambers 731A through 731D and the ink chambers 732A through 732D each extending in the X-axis direction. It should be noted that the ink chambers 731A through 731D are disposed at positions corresponding respectively to the flow channels 461A through 461D in the Z-axis direction, and the ink chambers 732A through 732D are disposed at positions corresponding respectively to the flow channels 462A through 462D in the Z-axis direction. It should be noted that in FIG. 7, a pair of ink chambers 731A, 732A and a pair of ink chambers 731B, 732B are shown alone out of the ink chambers 731A through 731D, 732A through 732D. The pair of ink chambers 731A, 732A are formed in the area corresponding to the channel column 721 (the plurality of channels C1) in the actuator plate 72. Further, the pair of ink chambers 731B, 732B are formed in the area corresponding to the channel column 722 (the plurality of channels C2) in the actuator plate 72.

The ink chamber 731A is formed in the vicinity of an inner end part along the Y-axis direction in each of the channels C1, and forms a groove section having a recessed shape. In areas corresponding respectively to the ejection channels C1e in the ink chamber 731A, there are respectively formed supply slits Sa penetrating the cover plate 73 along the thickness direction (the Z-axis direction) of the cover plate 73. Similarly, the ink chamber 731B is formed in the vicinity of an inner end part along the Y-axis direction in each of the channels C2, and forms a groove section having a recessed shape. In this ink chamber 731B, the area corresponding to each of the ejection channels C2e is also provided with the supply slit Sa described above.

As shown in FIG. 7, the ink chamber 732A is formed in the vicinity of an outer end part along the Y-axis direction in each of the channels C1, and forms a groove section having a recessed shape. In areas corresponding respectively to the ejection channels C1e in the ink chamber 732A, there are respectively formed discharge slits Sb penetrating the cover plate 73 along the thickness direction of the cover plate 73. Similarly, the ink chamber 732B is formed in the vicinity of an outer end part along the Y-axis direction in each of the channels C2, and forms a groove section having a recessed shape. In this ink chamber 732B, the area corresponding to each of the ejection channels C2e is also provided with the discharge slit Sb described above.

In such a manner, the ink chamber 731A and the ink chamber 732A are each communicated with the ejection channel C1e via the supply slit Sa and the discharge slit Sb on the one hand, but are not communicated with the dummy channels C1d on the other hand. Specifically, each of the dummy channels C1d is arranged to be closed by bottom parts of the ink chamber 731A and the ink chamber 732A.

Similarly, the ink chamber 731B and the ink chamber 732B are each communicated with the ejection channel C2e via the supply slit Sa and the discharge slit Sb on the one hand, but are not communicated with the dummy channels C2d on the other hand. Specifically, each of the dummy channels C2d is arranged to be closed by bottom parts of the ink chamber 731B and the ink chamber 732B.

### [Method of Manufacturing Inkjet Heads 4]

Then, a method of manufacturing the inkjet heads 4 will be described. The method of manufacturing the inkjet heads 4 according to the present embodiment includes a head chip fabrication process for fabricating the head chip 41, a flow channel member fabrication process for fabricating the flow channel member 45, and a plate bonding process for bonding the head chip 41 and the flow channel member 45 to each other. Among these processes, a known method can be used in the processes other than the plate bonding process. Therefore, the plate bonding process will hereinafter be described.

### <Plate Bonding Process>

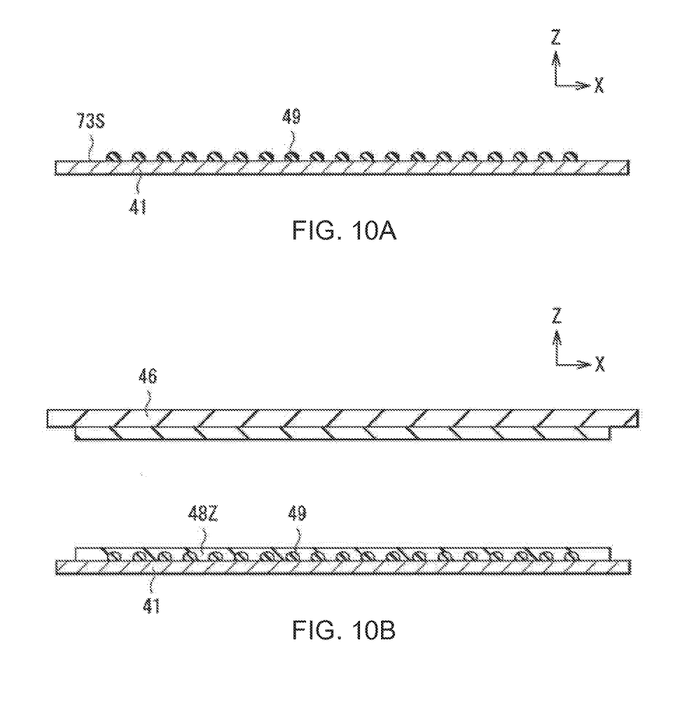

FIG. 10A is a schematic cross-sectional view showing a first process in the plate bonding process. Here, the head chip 41 is firstly prepared, and then, the plurality of elastic bodies 49 arranged in the X-axis direction is formed in a dotted pattern on the upper surface of the cover plate 73 as shown in FIG. 10A. On this occasion, as shown in, for example, FIG. 5B, a column of the plurality of elastic bodies 49 is formed in each of four regions in the flow channel plate 46, namely a region between the flow channel 461A and the flow channel 462A, a region between the flow channel 461B and the flow channel 462B, a region between the flow channel 461C and the flow channel 462C, a region between the flow channel 461D and the flow channel 462D. The elastic bodies 49 are formed by ejecting, for example, a liquid-like raw material, a paste-like raw material or a gel-like raw material on the upper surface of the cover plate 73 by a given amount using a dispenser or the like to attach the raw material to the upper surface. As the raw material of the elastic bodies 49, there is used a material which is softer than the adhesive later 48 having cured in the completion stage.

FIG. 10B is a schematic cross-sectional view showing a second process in the plate bonding process. After forming the elastic bodies 49, as shown in FIG. 10B, an adhesive 48Z as a raw material of the adhesive layer 48 is applied so as to cover the upper surface (the upper surface 73S of the cover plate 73) of the head chip 41 and the elastic bodies 49. It should be noted that it is also possible to apply the adhesive 48Z also to a lower surface (a surface opposed to the cover plate 73) of the flow channel plate 46 as shown in FIG. 10B. Alternatively, it is also possible to apply the adhesive 48Z either one of the upper surface of the cover plate 73 and the lower surface of the flow channel plate 46. In either case, the adhesive 48Z is applied so as to selectively cover the areas other than the areas where the flow channels 461A through 461D, 462A through 462D are formed so as not to block the flow channels 461A through 461D, 462A through 462D.

Subsequently, the cover plate 73 and the flow channel plate 46 are made to adhere to each other via the adhesive 48Z so that the upper surface of the cover plate 73 provided with the elastic bodies 49 and the lower surface of the flow channel plate 46 are opposed to each other. Heating or drying is performed in that state to thereby make the adhesive 48Z cure to form the adhesive layer 48. Due to the above, the plate bonding process is completed to achieve the state in which the flow channel member 45 and the head chip 41 are bonded to each other with the adhesive layer 48 while sandwiching the elastic bodies 49 between the flow channel member 45 and the head chip 41 (FIG. 5A).

### [Operations]

### (A. Basic Operation of Printer 1)

In the printer 1, a recording operation (a printing operation) of images, characters, and so on to the recording paper P is performed in the following manner. It should be noted that as an initial state, it is assumed that the four types of ink tanks 3 (3Y, 3M, 3C, and 3B) shown in FIG. 1 are sufficiently filled with the ink of the corresponding colors (the four colors), respectively. Further, there is achieved the state in which the inkjet heads 4 are filled with the ink 9 in the ink tanks 3 via the ink circulation mechanism 5, respectively.

In such an initial state, when operating the printer 1, the grit rollers 21 in the carrying mechanisms 2a, 2b rotate to thereby carry the recording paper P along the carrying direction d (the X-axis direction) between the grit rollers 21 and the pinch rollers 22. Further, at the same time as such a carrying operation, the drive motor 633 in the drive mechanism 63 respectively rotates the pulleys 631a, 631b to thereby operate the endless belt 632. Thus, the carriage 62 reciprocates along the width direction (the Y-axis direction) of the recording paper P while being guided by the guide rails 61a, 61b. Then, on this occasion, the four colors of ink 9 are appropriately ejected on the recording paper P by the respective inkjet heads 4 (4Y, 4M, 4C, and 4B) to thereby perform the recording operation of images, characters, and so on to the recording paper P.

### (B. Detailed Operation in Inkjet Heads 4)

Then, the detailed operation (the jet operation of the ink 9) in the inkjet head 4 will be described with reference to FIGS. 1, 2, 7 through 9 and so on. Specifically, in the inkjet heads 4 (the side-shoot type, the circulation type inkjet heads) according to the present embodiment, the jet operation of the ink 9 using a shear mode is performed in the following manner.

Firstly, when the reciprocation of the carriage 62 (see FIG. 1) described above is started, the control mechanism 43 applies the drive voltages to the drive electrodes Ed (the common electrodes Edc and the active electrodes Eda) in the inkjet head 4 via the flexible printed circuit board 74. Specifically, the control mechanism 43 applies the drive voltage to the drive electrodes Ed disposed on the pair of drive walls Wd forming the ejection channel C1e, C2e. Thus, the pair of drive walls Wd each deform (see FIG. 9) so as to protrude toward the dummy channel C1d, C2d adjacent to the ejection channel C1e, C2e.

Here, as described above, in the actuator plate 72, the polarization direction differs along the thickness direction (the two piezoelectric substrates described above are stacked on one another), and at the same time, the drive electrodes Ed are formed in the entire area in the depth direction on the inner side surface in each of the drive walls Wd. Therefore, by applying the drive voltage using the drive circuit described above, it results that the drive wall Wd makes a flexion deformation to have a V shape centered on the intermediate position in the depth direction in the drive wall Wd. Further, due to such a flexion deformation of the drive wall Wd, the ejection channel C1e, C2e deforms as if the ejection channel C1e, C2e bulges. Incidentally, in the case in which the configuration of the actuator plate 72 is not the chevron type but is the cantilever type described above, the drive wall Wd makes the flexion deformation to have the V shape in the following manner. That is, in the case of the cantilever type, since it results that the drive electrode Ed is attached by the oblique evaporation to an upper half in the depth direction, by the drive force exerted only on the part provided with the drive electrode Ed, the drive wall Wd makes the flexion deformation (in the end part in the depth direction of the drive electrode Ed). As a result, even in this case, since the drive wall Wd makes the flexion deformation to have the V shape, it results that the ejection channel C1e, C2e deforms as if the ejection channel C1e, C2e bulges.

As described above, due to the flexion deformation caused by a piezoelectric thickness-shear effect in the pair of drive walls Wd, the capacity of the ejection channel C1e, C2e increases. Further, due to the increase of the capacity of the ejection channel C1e, C2e, it results that the ink 9 retained in the ink chamber 731A, 731B is induced into the ejection channel C1e, C2e.

Subsequently, the ink 9 having been induced into the ejection channel C1e, C2e in such a manner turns to a pressure wave to propagate to the inside of the ejection channel C1e, C2e. Then, the drive voltage to be applied to the drive electrodes Ed becomes 0 (zero) V at the timing at which the pressure wave has reached the nozzle H1, H2 of the nozzle plate 71. Thus, the drive walls Wd are restored from the state of the flexion deformation described above, and as a result, the capacity of the ejection channel C1e, C2e having once increased is restored again (see FIG. 9).

When the capacity of the ejection channel C1e, C2e is restored in such a manner, the internal pressure of the ejection channel C1e, C2e increases, and the ink 9 in the ejection channel C1e, C2e is pressurized. As a result, the ink 9 having a droplet shape is ejected (see FIG. 9) toward the outside (toward the recording paper P) through the nozzle H1, H2. The jet operation (the ejection operation) of the ink 9 in the inkjet head 4 is performed in such a manner, and as a result, the recording operation of images, characters, and so on to the recording paper P is performed.

In particular, the nozzles H1, H2 of the present embodiment each have the tapered shape gradually decreasing in diameter in the downward direction (see FIG. 9) as described above, and can therefore eject the ink 9 straight (good in straightness) at high speed. Therefore, it becomes possible to perform recording high in image quality.

### [Functions and Advantages]

Then, the functions and the advantages in the inkjet head 4 and the printer 1 according to the present embodiment will be described in detail.

In the inkjet head 4 according to the present embodiment, it is arranged that the elastic bodies 49 softer than the adhesive layer 48 for bonding the head chip 41 and the flow channel member 45 to each other are provided between the head chip 41 and the flow channel member 45. Therefore, compared to the case in which the elastic members 49 are not provided, the pressure wave generated in the head chip 41 in the ejection operation of a certain ejection channel C1e is absorbed by the elastic bodies 49, and thus, the propagation of the unwanted pressure wave to other ejection channels C1e adjacent to the certain ejection channel C1e is suppressed. Therefore, the harmful influence to the ejection operation of other ejection channels C1e is avoided, and the stable jet operation becomes possible. Further, according to the method of manufacturing the liquid jet head according to the embodiment of the present disclosure, it is possible to manufacture the liquid jet head capable of such a stable jet operation.

Further, in the inkjet head 4 according to the present embodiment, the elastic bodies 49 are disposed so as to have contact with the head chip 41. Due to such a configuration, it becomes easy for the pressure wave generated in the head chip 41 to propagate to the elastic bodies 49, and thus, the pressure wave propagating toward other ejection channels C1e adjacent to the election channel C1e performing the jet operation becomes easier to be attenuated.

Further, in the inkjet head 4 according to the present embodiment, the elastic bodies 49 are disposed so as to be separated from the ink 9 at least by the adhesive layer 48. Since the elastic bodies 49 do not have direct contact with the ink 9 in such a manner, the elastic bodies 49 can be formed even from a material not provided with the resistance to the ink. Therefore, the design freedom in selecting the constituent material of the elastic bodies 49 increases.

Further, in the inkjet head 4 according to the present embodiment, the adhesive layer 48 and the elastic bodies 49 are disposed at the positions corresponding to the peripheral area other than the area occupied by the flow channels 461, 462 in the flow channel plate 46. Therefore, a good jet operation of the ink 9 is performed without hindering the flow of the ink 9.

Further, in the inkjet head 4 according to the present embodiment, it is arranged that the plurality of elastic bodies 49 is discretely disposed along the extending direction (the X-axis direction) of the flow channels 461, 462. Therefore, compared to the case of linearly disposing the elastic body along the extending direction of the flow channels 461, 462, it is easy to increase the bonding area of the adhesive layer 48, and it is easy to increase the bonding strength.

Further, in the inkjet head 4 according to the present embodiment, in the case of forming the elastic bodies 49 from an adhesive, it is possible to further increase the adhesive force between the head chip 41 and the flow channel member 45.

Further, in the method of manufacturing the inkjet head 4 according to the present embodiment, it is arranged to apply the adhesive 48Z to at least one of the head chip 41 (the cover plate 73) and the flow channel member 45 (the flow channel plate 46) after forming the elastic bodies 49 on the head chip 41 (the cover plate 73). By adopting such a configuration, the elastic bodies 49 surely have contact with the head chip 41 (the cover plate 73). As a result, it becomes easy for the pressure wave generated in the head chip 41 to propagate to the elastic bodies 49, and thus, the pressure wave propagating toward other ejection channels C1e adjacent to the election channel C1e performing the jet operation becomes easier to be attenuated.

### 2. MODIFIED EXAMPLES

Then, some modified examples (Modified Examples 1 through 4) of the embodiment described above will be described. It should be noted that the same constituents as those in the embodiment are denoted by the same reference symbols, and the description thereof will arbitrarily be omitted.

### Modified Example 1

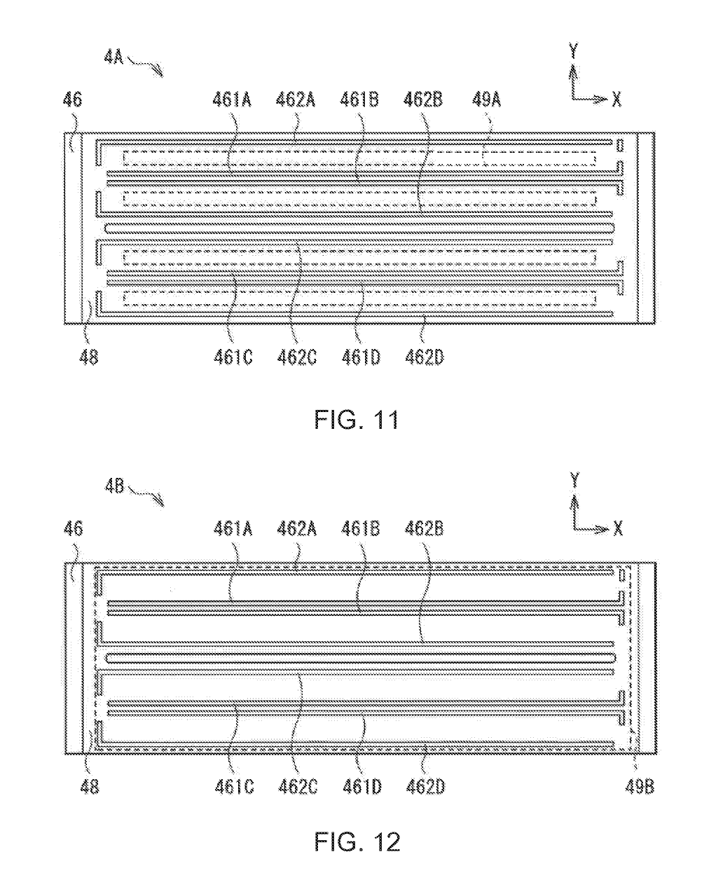

FIG. 11 is a schematic plan view showing a vicinity of an interface between the flow channel member 45 and the head chip 41 in an inkjet head 4A according to Modified Example 1. In the inkjet head 4 according to the embodiment described above, it is arranged that the plurality of elastic bodies 49 is discretely disposed along the extending direction (the X-axis direction) of the flow channels 461, 462. In contrast, in the inkjet head 4A according to Modified Example 1 shown in FIG. 11, it is arranged to dispose linear elastic bodies 49A each extending along the extending direction (the X-axis direction) of the flow channels 461, 462. Here, since the head chip 41 has a plurality of ejection channels C1e each extending in the Y-axis direction and arranged side by side in the X-axis direction, it results that the linear elastic bodies 49A are each disposed so as to traverse the plurality of ejection channels C1e. In other words, the elastic bodies 49A each extend along the arrangement direction of the ejection channels C1e, and by extension, the extending direction of the flow channels 461, 462. Therefore, the transmission of the pressure wave from a certain ejection channel C1e to be the generation source of the pressure wave to other ejection channels C1e adjacent to that ejection channel C1e is sufficiently suppressed. Further, since the total volume of the elastic bodies 49A can originally be increased compared to the inkjet head 4 according to the embodiment described above, it is possible to increase the attenuation amount of the pressure wave. Therefore, it is possible to realize the liquid jet operation more excellent in stability.

### Modified Example 2

FIG. 12 is a schematic plan view showing a vicinity of an interface between the flow channel member 45 and the head chip 41 in an inkjet head 4B according to Modified Example 2. In the inkjet head 4, it is arranged that the plurality of elastic bodies 49 is discretely disposed along the extending direction (the X-axis direction) of the flow channels 461, 462. In contrast, in the inkjet head 4B according to Modified Example 2 shown in FIG. 12, it is arranged to dispose an elastic body 49B as a sheet-shaped member having slits at positions corresponding respectively to the flow channels 461, 462. In Modified Example 2, the elastic body 49B is a sheet-shaped member formed integrally, and can therefore exert a high attenuation effect (is excellent in attenuation efficiency) with respect to the pressure wave. Further, it is also possible to perform gap management between the head chip 41 and the flow channel member 45 by managing the thickness of the elastic body 49B as the sheet-shaped member. Further, compared to the case of forming the plurality of dot-like elastic bodies 49 using a dispenser or the like as in the embodiment described above, it is possible to form the elastic body 49B with ease and in a short time.

### Modified Example 3

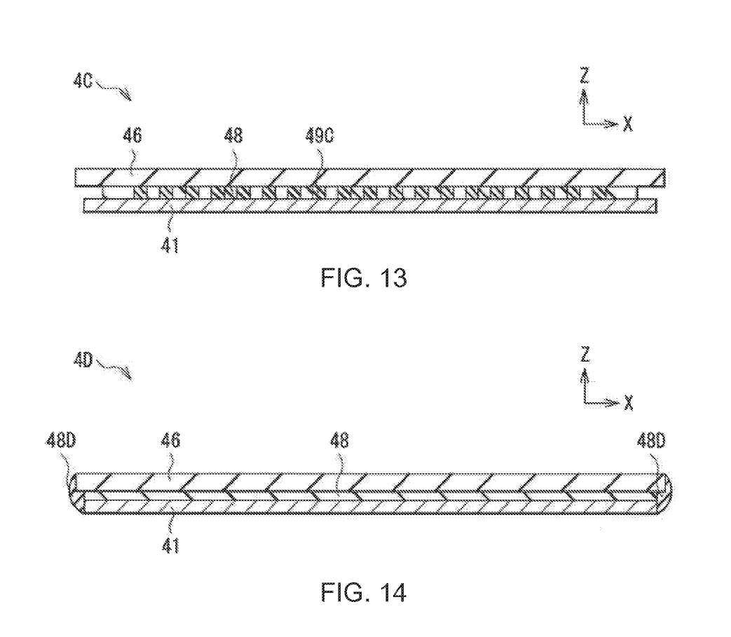

FIG. 13 is a schematic cross-sectional view showing a vicinity of an interface between the flow channel member 45 and the head chip 41 in an inkjet head 4C according to Modified Example 3. In the inkjet head 4 according to the embodiment described above, it is arranged that the plurality of elastic bodies 49 has contact with the upper surface of the head chip 41 (the cover plate 73) on the one hand, and a part of the adhesive layer 48 intervenes between the plurality of elastic members 49 and the lower surface of the flow channel member 45 (the flow channel plate 46) on the other hand. In contrast, an inkjet head 4C according to Modified Example 3 shown in FIG. 13 has elastic bodies 49C each disposed so as to have contact with both of the lower surface of the flow channel member 45 (the flow channel plate 46) and the upper surface of the head chip 41 (the cover plate 73). In Modified Example 3, since there is a place where the adhesive layer 48 harder than the elastic bodies 49 does not intervene, the pressure wave propagating toward other adjacent ejection channels C1e becomes easier to be attenuated. It should be noted that as described with reference to FIG. 10A and FIG. 10B, the inkjet head 4C according to Modified Example 3 can be manufactured by forming the elastic bodies 49 on the lower surface of the cover plate 73 in the head chip 41, and then applying the adhesive 48Z and at the same time mounting the flow channel plate 46. Alternatively, the inkjet head 4C can be manufactured by forming the elastic bodies 49 on the upper surface of the flow channel plate 46, and then applying the adhesive 48Z and at the same time mounting the cover plate 73 in the head chip 41.

### Modified Example 4

FIG. 14 is a schematic cross-sectional view showing a vicinity of an interface between the flow channel member 45 and the head chip 41 in an inkjet head 4D according to Modified Example 4. In the inkjet head 4D, an adhesive layer 48D for bonding an end surface of the flow channel member 45 (the flow channel plate 46) and an end surface of the head chip 41 (the cover plate 73) to each other is further provided in addition to the configuration of the inkjet head 4B according to Modified Example 2 described above. In Modified Example 4, by further providing the adhesive layer 48D to the configuration of the inkjet head 4B of Modified Example 2, it is possible to sufficiently prevent the leakage of the ink 9 in addition to substantially the same advantages in Modified Example 2. Specifically, even in the case in which the ink 9 is leaked from a gap between the elastic body 49B and the flow channel plate 46 or a gap between the elastic body 49B and the head chip 41, the leakage of the ink 9 to the outside can be prevented by damming the ink 9 with the adhesive layer 48D.

### 3. OTHER MODIFIED EXAMPLES

The present disclosure is described hereinabove citing the embodiment and some modified examples, but the present disclosure is not limited to the embodiment and so on, and a variety of modifications can be adopted.

For example, in the embodiment described above, the description is presented specifically citing the configuration examples (the shapes, the arrangements, the number and so on) of each of the members in the printer, the inkjet head and the head chip, but those described in the above embodiment and so on are not limitations, and it is possible to adopt other shapes, arrangements, numbers and so on.

Specifically, although the dot-like elastic bodies, the linear elastic bodies, and the sheet-shaped elastic body, for example, are illustrated in the embodiment described above and so on, other shapes than those described above can be adopted in the elastic body of the present disclosure. Further, the layout positions of the elastic bodies are not limited to those cited in the embodiment described above and so on.

Further, in the above embodiment, the description is presented citing the printer 1 (the inkjet printer) as a specific example of the “liquid jet recording device” in the present disclosure, but this example is not a limitation, and it is also possible to apply the present disclosure to other devices than the inkjet printer. In other words, it is also possible to arrange that the “liquid jet head” (the inkjet head 4) of the present disclosure is applied to other devices than the inkjet printer. Specifically, for example, it is also possible to arrange that the “liquid jet head” of the present disclosure is applied to a device such as a facsimile or an on-demand printer.

Further, although it is arranged to dispose the adhesive layer 48 between the flow channel member 45 (the flow channel plate 46) and the head chip 41 (the cover plate 73) in the embodiment described above and so on, the present disclosure is not limited to this configuration. For example, in the inkjet head 4D according to Modified Example 4 shown in FIG. 14, it is also possible to provide only the adhesive layer 48D for bonding the end surface of the flow channel member 45 (the flow channel plate 46) and the end surface of the head chip 41 (the cover plate 73) to each other without disposing the adhesive layer 48 between the flow channel member 45 (the flow channel plate 46) and the head chip 41 (the cover plate 73). By adopting such a configuration, it is possible to prevent the vibration due to the jet operation of the ejection channel C1e from being transmitted to other ejection channels C1e via the adhesive layer 48 to thereby make the elastic bodies 49 further attenuate the vibration. It should be noted that in that case, there is provided a partitioning structure for preventing the flow channels 461A through 461D on the entrance side and the flow channels 462A through 462D on the exit side from being communicated with each other in the flow channel pate 46.

Further, the description is presented citing a so-called side-shoot type inkjet head in the embodiment described above and so on, but the present disclosure is not limited to this example. In the present disclosure, it is also possible to adopt a so-called edge-shoot type inkjet head for ejecting the ink along the extending direction the plurality of channels in the head chip.

It should be noted that the advantages described in the specification are illustrative only but are not a limitation, and another advantage can also be provided.

Further, the present disclosure can also take the following configurations.
<1>

A liquid jet head comprising a liquid jet head chip adapted to jet liquid; a flow channel member having a flow channel adapted to guide the liquid to the liquid jet head chip; an adhesive layer adapted to bond the flow channel member and the liquid jet head chip to each other; and an elastic body softer than the adhesive layer and disposed between the flow channel member and the liquid jet head chip.
<2>

The liquid jet head according to <1>, wherein the elastic body is disposed so as to have contact with the liquid jet head chip.
<3>

The liquid jet head according to <1> or <2>, wherein the elastic body is disposed so as to be separated from the liquid at least by the adhesive layer.
<4>

The liquid jet head according to any one of <1> to <3>, wherein the adhesive layer and the elastic body are disposed at positions corresponding to a peripheral area other than an area occupied by the flow channel in the flow channel member.
<5>

The liquid jet head according to any one of <1> to <4>, wherein the liquid jet head chip has a plurality of ejection channels arranged in an extending direction of the flow channel, and each extending in a direction crossing the extending direction of the flow channel, and the elastic body is disposed so as to traverse the plurality of ejection channels along the extending direction of the flow channel.
<6>

The liquid jet head according to any one of <1> to <4>, wherein a plurality of the elastic bodies is discretely disposed along the extending direction of the flow channel.
<7>

The liquid jet head according to any one of <1> to <4>, wherein the elastic body is a sheet-shaped member having a slit at a position corresponding to the flow channel.
<8>

The liquid jet head according to any one of <1> to <7>, wherein the elastic body is an adhesive.
<9>

The liquid jet head according to any one of <1> to <8>, wherein a Young's modulus of the elastic body is lower than a Young's modulus of the adhesive layer.
<10>

A liquid jet recording device comprising the liquid jet head according to any one of <1> to <9>; and a carriage to which the liquid jet head is attached.
<11>

A method of manufacturing a liquid jet head, comprising preparing a flow channel member having a flow channel, and a liquid jet head chip; disposing an elastic body between the flow channel member and the liquid jet head chip; and curing the adhesive to thereby form an adhesive layer adapted to bond the flow channel member and the liquid jet head chip to each other, wherein the elastic body is formed from a material softer than the adhesive layer having cured.
<12>

The method of manufacturing the liquid jet head according to <11>, wherein the elastic body is formed on the liquid jet head chip, and then the adhesive is applied to at least one of the liquid jet head chip and the flow channel member.

What is claimed is:

1. A liquid jet head comprising:
a liquid jet head chip adapted to jet liquid;
a flow channel member having a flow channel adapted to guide the liquid to the liquid jet head chip;
an adhesive layer adapted to bond the flow channel member and the liquid jet head chip to each other; and
an elastic body softer than the adhesive layer and disposed between the flow channel member and the liquid jet head chip.

2. The liquid jet head according to claim 1, wherein
the elastic body is disposed so as to have contact with the liquid jet head chip.

3. The liquid jet head according to claim 1, wherein
the elastic body is disposed so as to be separated from the liquid at least by the adhesive layer.

4. The liquid jet head according to claim 1, wherein
the adhesive layer and the elastic body are disposed at positions corresponding to a peripheral area other than an area occupied by the flow channel in the flow channel member.

5. The liquid jet head according to claim 1, wherein
the liquid jet head chip has a plurality of ejection channels arranged in an extending direction of the flow channel, and each extending in a direction crossing the extending direction of the flow channel, and
the elastic body is disposed so as to traverse the plurality of ejection channels along the extending direction of the flow channel.

6. The liquid jet head according to claim 1, wherein
a plurality of the elastic bodies is discretely disposed along the extending direction of the flow channel.

7. The liquid jet head according to claim 1, wherein
the elastic body is a sheet-shaped member having a slit at a position corresponding to the flow channel.

8. The liquid jet head according to claim 1, wherein
the elastic body is an adhesive.

9. The liquid jet head according to claim 1, wherein
a Young's modulus of the elastic body is lower than a Young's modulus of the adhesive layer.

10. A liquid jet recording device comprising:
the liquid jet head according to claim 1; and
a carriage to which the liquid jet head is attached.

11. A method of manufacturing a liquid jet head, comprising:
preparing a flow channel member having a flow channel, and a liquid jet head chip;
disposing an elastic body between the flow channel member and the liquid jet head chip; and
curing the adhesive to thereby form an adhesive layer adapted to bond the flow channel member and the liquid jet head chip to each other,
wherein the elastic body is formed from a material softer than the adhesive layer having cured.

12. The method of manufacturing the liquid jet head according to claim 11, wherein
the elastic body is formed on the liquid jet head chip, and then the adhesive is applied to at least one of the liquid jet head chip and the flow channel member.
